(19) United States
(12) Patent Application Publication
(10) Pub. No.: US 2014/0302244 A1
(43) Pub. Date: Oct. 9, 2014

(54) METHOD FOR FORMING UNIFORM FILM-LAYERED STRUCTURE

(71) Applicant: ACHROLUX INC., Sunnyvale, CA (US)

(72) Inventors: Peiching Ling, Sunnyvale, CA (US); DeZhong Liu, Sunnyvale, CA (US)

(73) Assignee: ACHROLUX INC., Sunnyvale, CA (US)

(21) Appl. No.: 14/227,048

(22) Filed: Mar. 27, 2014

Related U.S. Application Data
(60) Provisional application No. 61/808,006, filed on Apr. 3, 2013.

(51) Int. Cl. B05D 5/06; B05D 1/06

(52) U.S. Cl. CPC B05D 5/06; B05D 1/06
USPC 427/468; 427/475; 118/500; 118/620

(57) ABSTRACT

A method for forming a uniform film layer structure, including providing a phosphorous powder and a first surface of an object, wherein the phosphorous powder has a plurality of phosphorous particles, at least a portion of a surface of each of the phosphorous particles is covered with an adhesive material, and the first surface does not contact the phosphorous powder; and adsorbing the phosphorous powder to the first surface of the object by using an electrostatic adsorption method.

### BACKGROUND OF THE INVENTION

1. Field of the Invention

The present invention relates to methods for forming a uniform film layer structure, and, more particularly, to a method for forming a uniform film layer structure that converts wavelengths of light emitting from an LED.

2. Description of Related Art

Phosphors have been widely used in the production of white-light LED packages or various blue pump LEDs (for example, yellow or red colors converted by phosphors) for producing light colors. The conventional methods for depositing phosphors on a blue LED die or a package include:

slurry method: phosphor particles are dispersed throughout a silicon resin, an epoxy resin or a solvent filler material, to form a mixture of phosphors, which is applied to an LED surface or the lens material of a package by various technologies such as spray-coating, dip-coating, dispensing, phosphors in a container, or molding on a support structure; and

electrophoretic deposition: phosphor particles are dispersed throughout an electrochemical solution, and then deposited on an LED wafer by a bias voltage bridging over an LED wafer and the electrochemical solution.

The above conventional methods have a difference in the uniformity of thickness across an LED surface or the interior of an LED package. The slurry method usually forms a particle layer with an uneven thickness, leading to inconsistent light spots of an LED and poor LED color uniformity as converted by phosphors. Moreover, it is difficult to use these conventional methods on a non-planar surface to form a uniform phosphorous layer, such that these conventional methods face big challenges in satisfying the requirements of lighting applications.

Accordingly, it is an important issue to form a uniform phosphorous material.

### SUMMARY OF THE INVENTION

The present invention provides a manufacturing method for depositing uniform phosphorous layers to various LED package structures or LED chips with high productivity.

Specifically, the present invention discloses a method for forming a uniform film layer structure, comprising providing a phosphorous powder and a first surface of an object, wherein the phosphorous powder comprises a plurality of phosphorous particles, at least a portion of a surface of each of the phosphorous particles is covered with an adhesive material, and the first surface does not contact the phosphorous powder; and adsorbing the phosphorous powder to the first surface of the object by using an electrostatic adsorption method.

The aforesaid method further comprises heating and adhering the adsorbed phosphorous powder to the first surface of the object, so as to form a phosphorous layer.

The present invention further provides a system for forming a uniform film layer structure, comprising a carrier for carrying a phosphorous powder; a carrying member disposed above the carrier for carrying an object; and a mask disposed between the carrier and the carrying member. The mask has at least one penetrated opening, and the opening is aligned below the object, such that the phosphorous powder passes the opening and is adsorbed to a first surface of the object.

In the conventional method, phosphors are usually dispersed in silicon resin or liquid, and then are placed on an LED surface or package, which cannot effectively and uniformly disperse phosphorous particles in the silicon resin or liquid. Moreover, after the phosphorous particles are dispersed in the resin, or after the liquid is applied to the LED or package, the dispersion uniformity of the phosphorous particles cannot be controlled. This results in that some phosphorous particles of a phosphorous particle layer formed by the conventional method may congregate and be connected and some may exist independently, thereby causing problems of inconsistent light color point of an LED product and unsatisfied color uniformity.

In the method of the present invention, at least a portion of the surface of each of the phosphorous particles is covered with an adhesive material, and is adsorbed to the first surface of the object by an electrostatic adsorption method. As such, the thickness of the adhesive material between any two of the stacked phosphorous particles is extremely thin, and thus each of the phosphorous particles is fixed. Further, the formed uniform film layer structure observed by a microscope is substantially stacked by the plurality of phosphorous particles, and thus is very uniform.

### BRIEF DESCRIPTIONS OF THE DRAWINGS

FIGS. 1A and 1B are schematic diagrams showing an embodiment of a method for forming a uniform film layer structure according to the present invention;

FIGS. 2A-2D illustrate the distribution of a phosphorous layer formed by the method according to the present invention comparing with that of a traditional slurry method; and

FIGS. 3A-3D show a method of the present invention using a mask to form a uniform film layer structure.

### DETAILED DESCRIPTION OF THE PREFERRED EMBODIMENTS

In the following, specific embodiments are provided to illustrate the detailed description of the present invention. Those skilled in the art can easily conceive the other advantages and effects of the present invention, based on the disclosure of the specification. The present invention can also be carried out or applied by other different embodiments. Each of the details in the specification of the present invention can also be modified or altered in view of different viewpoints and applications, without departing from the spirit of the creation of the present invention.

The structures, proportions, and sizes illustrated in the appended drawings of the specification of the present invention are merely for coping with the disclosure of the specification, in order to allow those skilled in the art to conceive and peruse it. The drawings are not for constraining the limitations of the present invention, such that they do not have any technical significance. Any structural modifications, alterations of proportions and adjustments of sizes, as long as not affecting the effect brought about by the present invention and the purpose achieved by the present invention, should fall within the range encompassed by the technical content disclosed in the present invention. At the same time, the language used in the specification of the present invention is merely for the clarity of expression, and not intended to limit the scope of the present invention. The alterations or adjustments of the relative relationships, while not substantially altering the technical content, can also be regarded as fallen within the scope of the present invention.

The present invention generally relates to material manufacturing and an optical equipment technology. More specifically, the examples of the present invention provide a method for forming a uniform material layer and a system, which can be used in an optical system (such as a phosphorous layer in the lens of an LED). The term “phosphor” used herein refers to any luminescent materials, which absorb light of one wavelength and emit light of a different wavelength. As used herein, the terms “phosphor” and “wavelength-conversion material” can be used interchangeably.

Firstly, a phosphorous powder is prepared. The phosphorous powder is manufactured by dispersing the phosphorous particles in an adhesive material to form a mixture, and then using a spray drying method to form the phosphorous powder from the mixture.

In order to properly disperse phosphorous particles or uniformly mix phosphorous particles with the adhesive material, the adhesive material is dissolved in a solvent to form a liquid solution. The selection of the solvent is not specifically limited. In an embodiment, the adhesive material is silicon resin, and any solvent that is dissolved with silicon resin can be selected.

In another embodiment, the adhesive material is powder, and the mixture is formed further by melting the mixture and then using the spray drying method to form the phosphorous powder from the melt mixture.

When the spray drying method is utilized, the mixture is sprayed to a vacuum chamber. At least a portion of a surface of each of the phosphorous particles is covered with the adhesive material, so as to form the phosphorous powder. The weight ratio of each of the phosphorous particles to the adhesive material covered thereon is between 1:5 to 1:20.

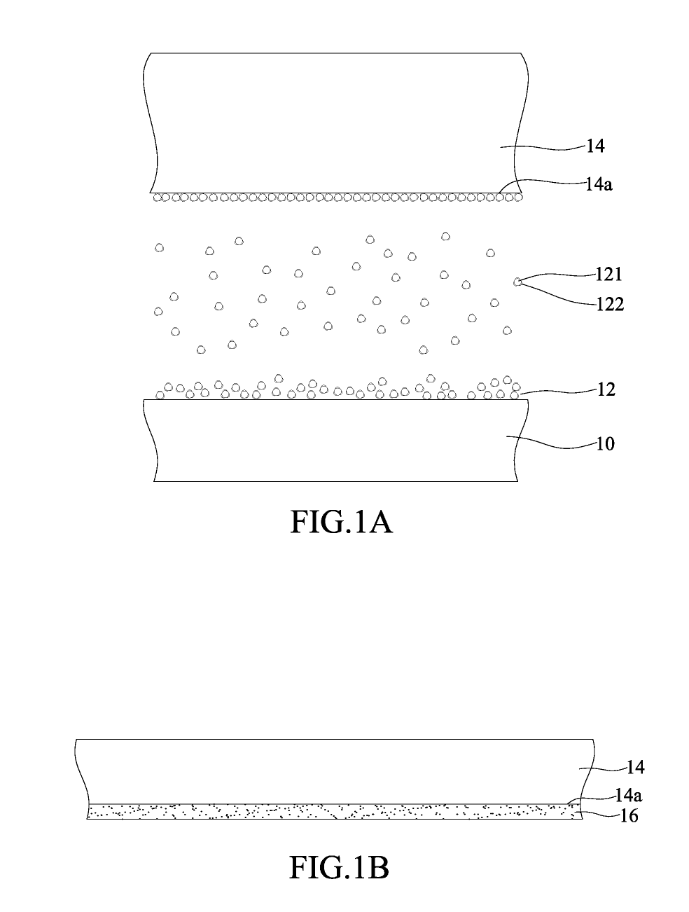

Please refer to FIGS. 1A and 1B, which illustrate an embodiment of a method for forming a uniform film layer structure according to the present invention.

A carrier 10 carrying or containing the phosphorous powder 12 is provided. The carrier 10 can be mounted with an electrostatic generator or can be applied with an electric field. An object 14 is further provided. The object 14 can be any object for forming a uniform film layer structure. In an embodiment, the object 14 is glass, an LED lens, a secondary optical component, an LED package, an LED die, or an LED wafer. The object 14 has a first surface 14a for forming the uniform film layer structure.

The phosphorous powder 12 comprises a plurality of phosphorous particles. At least a portion of the surface of each of the phosphorous particles is covered with the adhesive material. Before static charges are formed, the first surface 14a does not contact the phosphorous powder 12. In an embodiment, the first surface is away from the provided phosphorous powder by a distance of 5 to 30 cm. If the distance is too short, the phosphorous powder cannot be controlled to uniformly move toward the first surface 14a or the phosphorous powder may move too fast. Conversely, the phosphorous powder cannot be adsorbed if the distance is too long.

Subsequently, the phosphorous powder 12 is adsorbed to the first surface 14a of the object 14 by using an electrostatic adsorption method. In an embodiment, as shown in FIG. 1A, the phosphorus powder 12 carries static charges, which facilitates continuously adsorbing the phosphorous powder 12 carrying static charges to the first surface 14a of the object 14.

In an embodiment, the phosphorous powder is placed in a container or carried by a carrier, and an object is arranged above the container or carrier, such that the first surface of the object faces the phosphorous powder. When the electrostatic adsorption method is performed, an electric field is applied between the object and the phosphorous powder, such that a potential difference is formed between the first surface of the object and the phosphorous powder. Alternately, the phosphorous powder may carry static charges due to corona discharge, the object is reversed, and the phosphorous powder approaches the first surface of the object and is adsorbed thereon.

As shown in FIG. 1B, the adsorbed phosphorous powder is heated and adhered to a first surface 14a of the object 14 to form a phosphorous layer 16. Since at least a portion of the surface of each of the phosphorous particles is covered with the adhesive material, the formed phosphorous layer comprises a plurality of phosphorous particles stacked on one another and the adhesive material filled between adjacent phosphorous particles. The thickness of the adhesive material between any two of the stacked phosphorous particles is extremely thin, such that the heated adhesive material can fill interspace between phosphorous particles, and thus each of the phosphorous particles is fixed. Further, the formed uniform film layer structure observed by a microscope is substantially stacked by the plurality of phosphorous particles, and thus is very uniform.

In order to fix the phosphorous powder, the object can be heated in advance or when the phosphorous powder contacts the first surface of the object, such that the phosphorous powder is adhered to the first surface of the object.

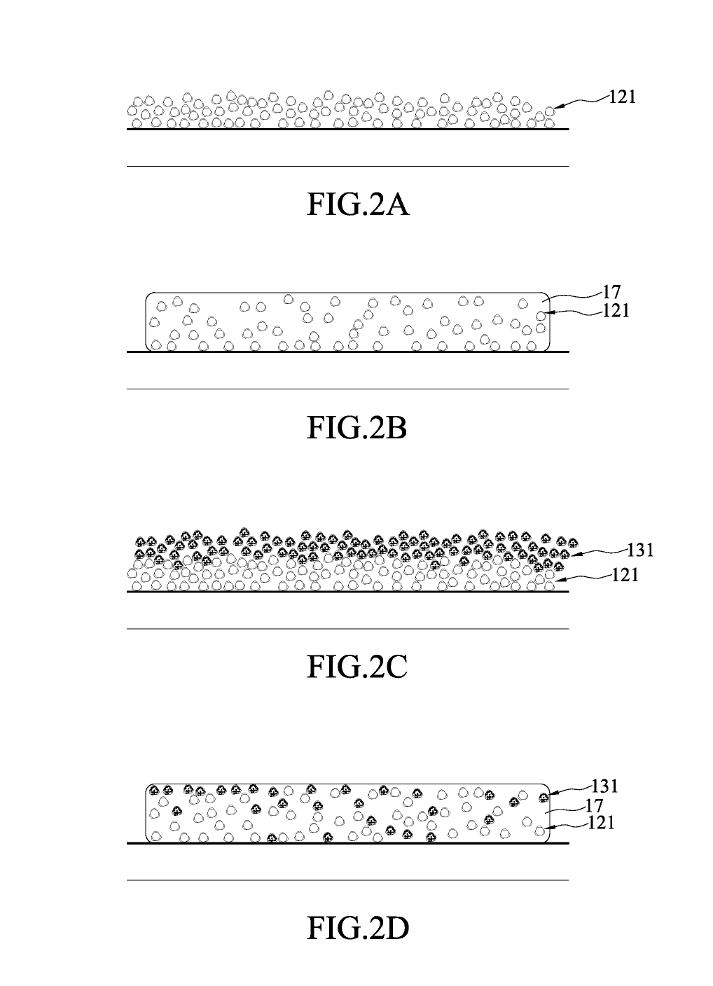

Refer to FIGS. 2A to 2D, which illustrate the distribution of a phosphorous layer formed by the method according to the present invention comparing with that of a traditional slurry method. FIG. 2A shows an embodiment of an encapsulation structure of deposited phosphorous particles according to the present invention, where phosphorous particles 121 are densely packed on the surface. Phosphorous powder occupies more than 50% of the volume of the phosphorous layer, and occupies even more than 75% of the volume of the phosphorous layer. This can be hardly implemented by the slurry method with a mixture of a phosphor and silicon resin 17 as shown in FIG. 2B, since the phosphor in the slurry will be deposited and cannot be uniformly distributed. Such densely packed phosphorous particles 121 as shown in FIG. 2A facilitate dissipating the heat generated due to a light conversion process inside the phosphorous particles 121, since the generated heat can be conducted and dissipated via the particles connected with one another, rather than being conducted via the silicon resin with poor heat conduction efficiency filled between the particles, as required in the slurry method. The facilitated heat dissipation also increases the conversion efficiency and improves the light attenuation due to the heat.

In an embodiment, different phosphorous particles 121 and 131 can be deposited in a layer structure as shown in FIG. 2C, where the phosphorous particles 121 and 131 form two different layers in the layer structure. In the slurry method, different phosphorous particles are distributed in the silicon resin 17 layer, such as the mixture of phosphor and silicon resin 17 as shown in FIG. 2D.

According to the embodiment of such layer structure of FIG. 2C of the present invention, color quality of light can be optimized by a sequence of the phosphorous particles with different property, so as to minimize the light reabsorption between the phosphorous particles with different light property and increase the light conversion efficiency.

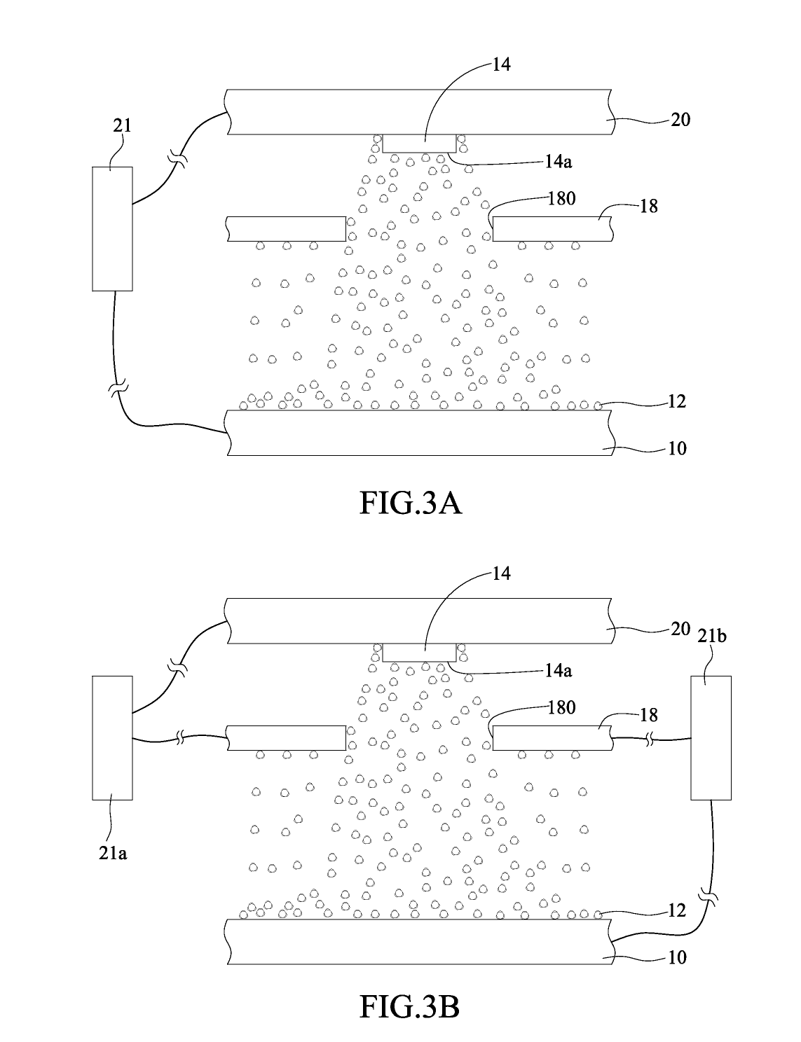

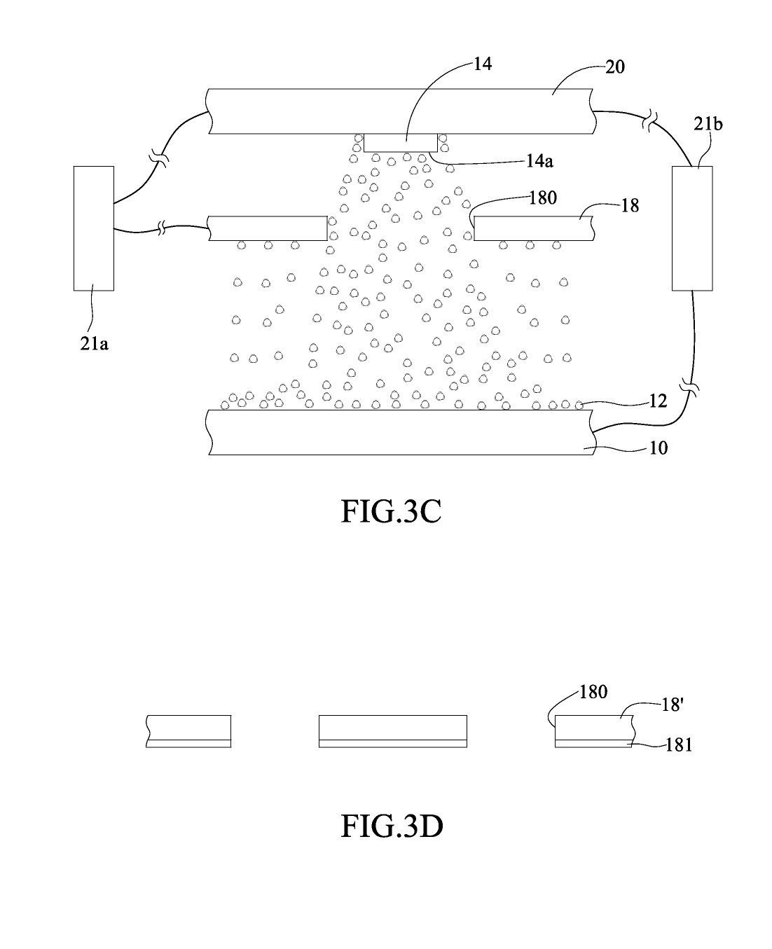

Refer to FIGS. 3A-3D, which show an embodiment for a method and system of using a mask to form a uniform film layer structure according to the present invention.

A system of forming a uniform film layer structure, as shown in FIGS. 3A-3D, comprises a carrier 10 for carrying a phosphorous powder 12; a carrying member 20 disposed above the carrier 10 for carrying an object 14; and a mask 18 disposed between the carrier 10 and the carrying member 20. The mask 18 has at least one penetrated opening 180, and the opening 180 is aligned below the object 14, such that the phosphorous powder 12 passes the opening 180 and is adsorbed on a first surface 14a of the object 14. The object 14 such as an LED die is disposed on the carrying member 20, and the mask 18 is closer to the object 14. In an embodiment, at least one voltage generator is utilized to be electrically connected to at least one of the carrying member 20, the carrier 10, and the mask 18. As shown in FIG. 3A, the voltage generator 21 is electrically connected to the carrying member 20 and the carrier 10. For example, the mask 18 may be grounded to control the potential difference between the carrying member 20 and the carrier 10, such that the phosphorous particles of the phosphorous powder 12 are limited in the opening 180 of the mask 18. The movement path of the phosphorous particles is slightly changed, and peripheral phosphorous particles will be adsorbed on a side edge of the LED die via a curved path, which facilitate the phosphorous powder 12 to completely encapsulate the LED die.

As shown in FIG. 3B, two voltage generators 21a and 21b are electrically connected to the carrying member 20 and the mask 18 and to the carrier 10 and the mask 18, respectively. As shown in FIG. 3C, two voltage generators 21a and 21b are electrically connected to the carrying member 20 and the mask 18 and to the carrying member 20 and the carrier 10.

The surface of the mask 18 is conductive. In an embodiment, the mask 18 is a conductor. As shown in FIG. 3D, a mask 18′ is an insulator, and a conductive layer 181 is on a surface of the mask 18′, such that the phosphorous powder 12 is prevented from being adsorbed to the mask 18. The system according to the present invention forms a uniform film layer on the object. Upon a test, the obtained product achieves a deviation value of CIE color space within +−70. In a general spray method, the deviation value of CIE color space is as high as +−400, and the product being tested has to be filtered in advance, otherwise the deviation value can be higher.

According to the method and system of using a mask to form a uniform film layer structure according to the present invention, the movement path of the phosphorous particles is more concentrated, thereby facilitating the formation of the uniform film layer without wasting phosphorous powder. In comparison, the used phosphorous powder is reduced to further decrease the cost.

The above examples are only used to illustrate the principle of the present invention and the effect thereof, and should not be construed as to limit the present invention. The above examples can all be modified and altered by those skilled in the art, without departing from the spirit and scope of the present invention as defined in the following appended claims.

What is claimed is:

1. A method for forming a uniform film layer structure, comprising:
providing a phosphorous powder and a first surface of an object, wherein the phosphorous powder comprises a plurality of phosphorous particles, at least a portion of a surface of each of the phosphorous particles is covered with an adhesive material, and the first surface does not contact the phosphorous powder; and
adsorbing the phosphorous powder to the first surface of the object by using an electrostatic adsorption method.

2. The method of claim 1, further comprising heating and adhering the adsorbed phosphorous powder to the first surface of the object, so as to form a phosphorous layer.

3. The method of claim 1, wherein the electrostatic adsorption method forms an electric potential difference between the first surface of the object and the phosphorous powder.

4. The method of claim 1, wherein the electrostatic adsorption method allows the phosphorous powder to carry electrostatic charges.

5. The method of claim 1, wherein the first surface is away from the phosphorous powder by a distance of 5 to 30 cm such that the first surface does not contact the phosphorous powder.

6. The method of claim 1, wherein the phosphorous powder is carried by a container or a carrier.

7. The method of claim 1, wherein phosphorous powder is fabricated by:
dispersing the phosphorous particles in the adhesive material to form a mixture; and
forming the phosphorous powder from the mixture by using a spray drying method.

8. The method of claim 7, wherein the adhesive material is dissolved in a solution.

9. The method of claim 7, wherein the adhesive material is powder, and the mixture is formed further by melting the mixture, and forming the phosphorous powder from the melt mixture by using the spray drying method.

10. The method of claim 7, wherein the mixture is sprayed to a vacuum chamber to form the phosphorous powder.

11. The method of claim 1, wherein the adhesive material is silicon resin.

12. The method of claim 1, wherein the phosphorous layer comprises a plurality of phosphorous particles stacked on one another, and the adhesive material filled between adjacent phosphorous particles.

13. The method of claim 1, wherein the object is glass, an LED lens, a secondary optical component, an LED package, an LED die, or an LED wafer.

14. The method of claim 1, wherein a mask is further disposed between the first surface and the phosphorous powder, and the mask has at least one penetrated opening, such that the phosphorous powder passes the opening and is adsorbed to the first surface of the object.

15. The method of claim 1, wherein a weight ratio of each of the phosphorous particles to the adhesive material covered thereon is between 1:5 to 1:20.

16. A system for forming a uniform film layer structure, comprising:
a carrier for carrying a phosphorous powder;
a carrying member above the carrier for carrying an object; and
a mask between the carrier and the carrying member, and the mask has at least one penetrated opening, such that the opening is aligned below the object, such that the phosphorous powder passes the opening and is adsorbed to a first surface of the object.

17. The system of claim 16, further comprising a voltage generator, which is electrically connected to at least one of the carrier, the carrying member, and the mask.

18. The system of claim 16, wherein a distance between the object and the phosphorous powder is 5 to 30 cm.

19. The system of claim 16, wherein the object is glass, an LED lens, a secondary optical component, an LED package, an LED die, or an LED wafer.

20. The system of claim 16, wherein the phosphorous powder comprises a plurality of phosphorous particles, at least a portion of a surface of each of the phosphorous particles is covered with an adhesive material, and the first surface does not contact the phosphorous powder.
